(19) United States
(12) Patent Application Publication
(10) Pub. No.: US 2011/0258665 A1
(43) Pub. Date: Oct. 20, 2011

(54) Viewing and Recording Streams

(75) Inventors: James William Fahrny, Englewood, CO (US); Mehul S. Patel, Denver, CO (US)

(73) Assignee: COMCAST CABLE COMMUNICATIONS, LLC, Philadelphia, PA (US)

(21) Appl. No.: 12/760,072

(22) Filed: Apr. 14, 2010

(51) Int. Cl. H04N 5/445; H04N 7/173

(52) U.S. Cl. 725/47; 725/93

(57) ABSTRACT

A system and method of providing content in a digital video network are disclosed. The system may detect the resolution capability of a user's device, and automatically configure electronic program guide (EPG), viewing and/or recording options accordingly. User preferences may also be used. Record and viewing requests may result in tuning to and decoding different datastreams.

### FIELD OF ART

The features described herein generally relate to video, in particular to high definition and standard definition video environments.

### BACKGROUND

The introduction of digital television, and high-definition (HD) television, has dramatically changed the video content landscape, and has renewed user interest in staying home to watch the TV. A typical television viewer may have access to dozens, or hundreds, of different television stations or networks (e.g., ESPN, ESPN2, HBO, HBO2, etc.). Many of those stations offer both a standard definition (SD) and HD version of the content carried on the station, so that viewers can choose whether to watch an SD or an HD version of the channel.

With multiple versions of so many different channels available, a television viewer can be overwhelmed. The viewer may have difficulty remembering which station offers an HD or SD alternative. Television listings may be provided using an on-screen electronic program guide (EPG) to help with this, but such listings are not always convenient to use, so viewers sometimes tune to an SD version without realizing that an HD version is available. Accordingly, there is an ever-present need to provide features to users in an accessible and convenient manner.

### SUMMARY

Features described herein generally provide consumers of various versions of content, such as HD and SD content, with greater flexibility in choosing how that content is accessed. In one general aspect, an interface device, such as a set-top box or a display device having an interface device, may automatically detect the capabilities of a display device to which it is connected, and may automatically choose a version of content such as an HD or SD version, that a viewer requests to view.

In one aspect, a video interface device may request user preference information identifying video resolution preferences for recording and viewing programs of a service provider. The preferences can be used to choose a service or datastream in response to a user request to view or record a program.

In some aspects, a user's request to record a program that is currently being viewed may automatically result in recording a version of the program at a different resolution from what was being viewed. The user's video device may automatically tune to a different resolution datastream for the program.

In some aspects, the interface device may automatically detect the display capabilities of a user's display device, and use that detected capability to customize a viewing experience. This customization may involve automatically tuning to a different datastream for viewing or recording, and editing listings in an EPG to remove service listings that are incompatible with the user's display device. The EPG may have an associated channel map that maps the listed services with different recording and viewing datastreams, depending on the detected capabilities and/or the user's preference.

The various features described above may be implemented using a computer or processing device, which may operate by executing computer-executable instructions for performing the various features described. Accordingly, some embodiments herein include the computer-readable media storing those instructions. Other details and features will also be described in the sections that follow.

### BRIEF DESCRIPTION OF THE DRAWINGS

Some features herein are illustrated by way of example, and not by way of limitation, in the figures of the accompanying drawings and in which like reference numerals refer to similar elements.

FIG. 1 illustrates an example information or content distribution network on which various features herein may be implemented.

FIG. 2 illustrates an example computing device configuration that can be used to implement the various devices described herein.

FIG. 3 illustrates an example electronic program guide (EPG) that can be used with features described herein.

FIGS. 4a-b illustrate a process flow with which features described herein may be implemented.

FIGS. 5a-b illustrate an EPG and logical selection flow for recording and viewing different services.

### DETAILED DESCRIPTION

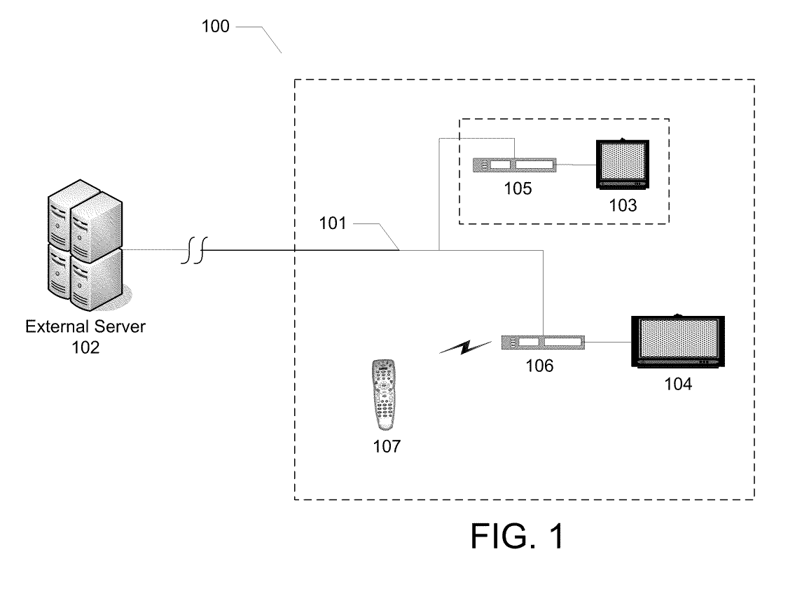

FIG. 1 illustrates an example premises or household 100. The household may include an in-home communication network 101, which can be coaxial wiring, Ethernet wiring, fiber optic wiring, telephone line wiring, wireless, or any other desired mode of communication.

The network 101 may be used by a variety of devices in the home to communicate with a device outside of the home, such as an external server 102. The external server 102 may be, for example, a local cable television headend, fiber optic node, a component therein such as a DOCSIS CMTS (Data Over Cable Service Interface Specification, Cable Modem Termination System), a server on the Internet, a satellite node, wireless node, or any other desired source of information to which devices in the home 100 may be connected.

Within the home 100, one type of device that can use the network 101 is a display device, such as a television. For example, users in the home may watch television programs on televisions 103, 104. These televisions may be directly connected to the network 101, or they may be connected using a video interface device, such as a digital video recorder (DVR), or set-top box (STB) 105, 106. Although they are illustrated separately from televisions 103, 104, the interface devices may be integral with their respectively display devices. Additionally, although STBs are used as examples in the discussion herein, the interface/display device may be any type of device, such as a gateway, personal computer (PC) devices, mobile television devices, portable media devices, cell phones, etc. FIG. 1 also illustrates an example wireless remote control 107, which the user may use to interact with the interface devices and/or televisions.

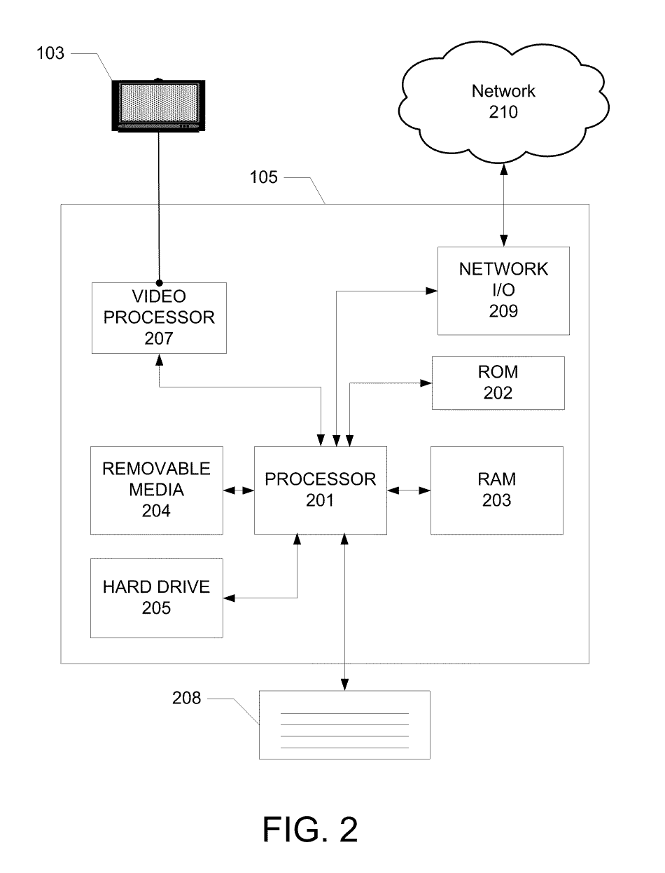

FIG. 2 illustrates the general hardware elements of an example video interface device 105, which may simply be any type of computing device such as an STB, digital video recorder (DVR), personal computer, mobile device, circuit embedded into the viewing device, etc. The device 105 may include one or more processors 201, which may execute instructions of a computer program to perform any of the features described herein. Those instructions may be stored in any type of computer-readable medium or memory, to configure the operation of the processor 201. For example, instructions may be stored in a read-only memory (ROM) 202, random access memory (RAM) 203, removable media 204, such as a Universal Serial Bus (USB) drive, compact disk (CD) or digital versatile disk (DVD), floppy disk drive, or any other desired electronic storage medium. Instructions may also be stored in an attached (or internal) hard drive 205. The device 105 may include one or more output devices, such as an external television 103 (or device 105 may be combined with television 103), and may include one or more output device controllers 207, such as a video processor. There may also be one or more user input devices 208, such as a remote control, keyboard, mouse, touch screen, microphone, etc. The device 105 may also include one or more network input/output circuits 209, such as a modem and/or network card to communicate with an external server 102 over network 210. The network interface may be a wired interface, wireless interface, or a combination of the two. In some embodiments, the interface 209 may include a modem, and network 210 may include a television system's coaxial, fiber, or hybrid fiber/coaxial distribution system (e.g., a DOCSIS network). Various types of modems, such as an optical fiber modems, may also be used.

The network input/output device 209 may include tuning and decoding circuitry to receive and decode various datastreams. The datastreams may be analog channels such as NTSC television channels, or digital channels such as DOCSIS data channels, MPEG (Moving Pictures Experts Group) datastreams, IP (Internet Protocol) data streams, optical datastreams, etc.

The video interface device 105 may allow a viewer to select content that is available from the server 102, and can tune to and/or decode a datastream carrying that content upon request (e.g., a video on demand VOD application). The content can be presented for viewing on a display device, such as a television.

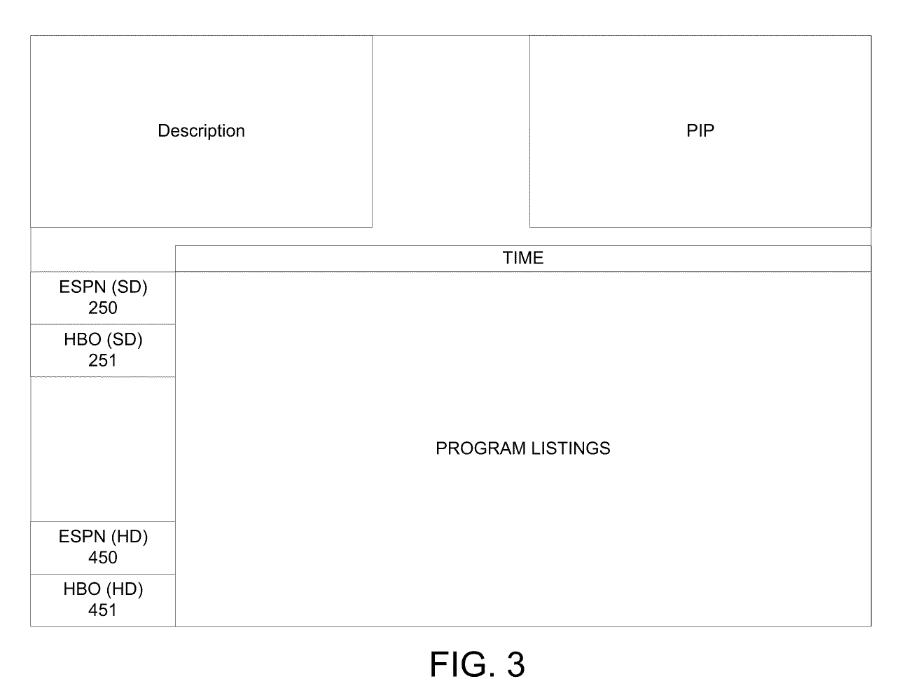

The display device can be used to select the content as well. For example, the device may generate, and display on a television, an EPG listing the various television programs that are available for viewing and/or download. FIG. 3 illustrates an example EPG, which lists various program services such as ESPN and HBO in a grid arranged by time, and which may also include a description of a highlighted program and a picture-in-picture version of a currently-tuned video program. Each of the listed services shown is listed twice: once with its standard definition (SD) lineup, and again with its high-definition (HD) lineup. The SD version may, for example, have a resolution of 480 lines per onscreen frame of video, such as in an NTSC video stream, while an HD version may have a higher resolution. The higher resolution may include more lines per onscreen frame (e.g., 720 lines, 1080 lines), progressive scan lines (e.g., in 720p and 1080p resolutions), and/or a greater screen refresh rate (e.g., 1080p24, 1080p30, 1080p60 may refresh the onscreen image 24, 30 and 60 times per second, respectively). The SD and HD examples herein may refer to any desired combination of different resolutions (e.g., one higher than the other). The above example describes a service having two listings, for two resolutions, but as more and more resolution formats become popular, a single service might be transmitted in 3, 4, or more resolutions, and each one might have listing in an EPG.

These different listings may correspond to different datastreams, each carrying a version of the service's offerings. To help users navigate the listing, the various versions may be assigned a channel number as well, with the SD and HD versions of a service having different channel numbers and being mapped via a channel map to different datastreams (e.g., ESPN SD is shown as channel 250, while ESPN HD is shown as channel 450, and they may each be mapped to different datastreams received by the device 105).

In some embodiments herein, the EPG can be configured to automatically customize the listings based on the display capabilities of the viewer's television. So, for example, if the viewer's television is an HD television, the EPG can automatically identify services that are simulcast in different formats (e.g., an SD HBO channel and an HD HBO channel), and remove the duplicate SD entries from the listing. It can automatically do this by automatically determining the resolution capability of the television during, for example, an initial configuration or installation.

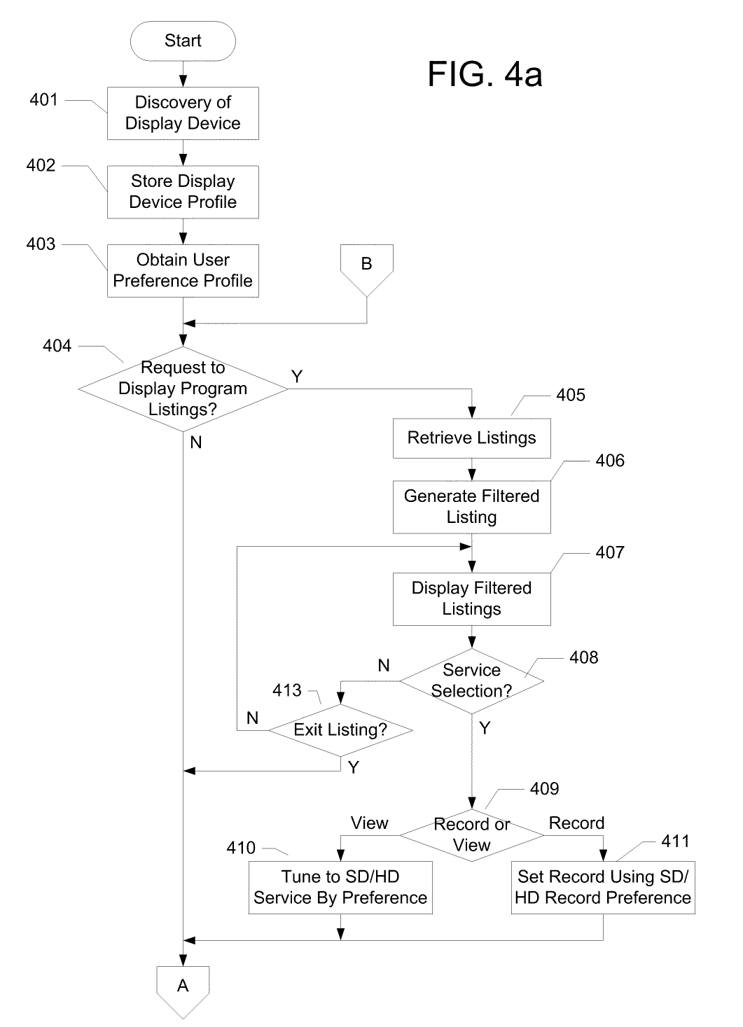

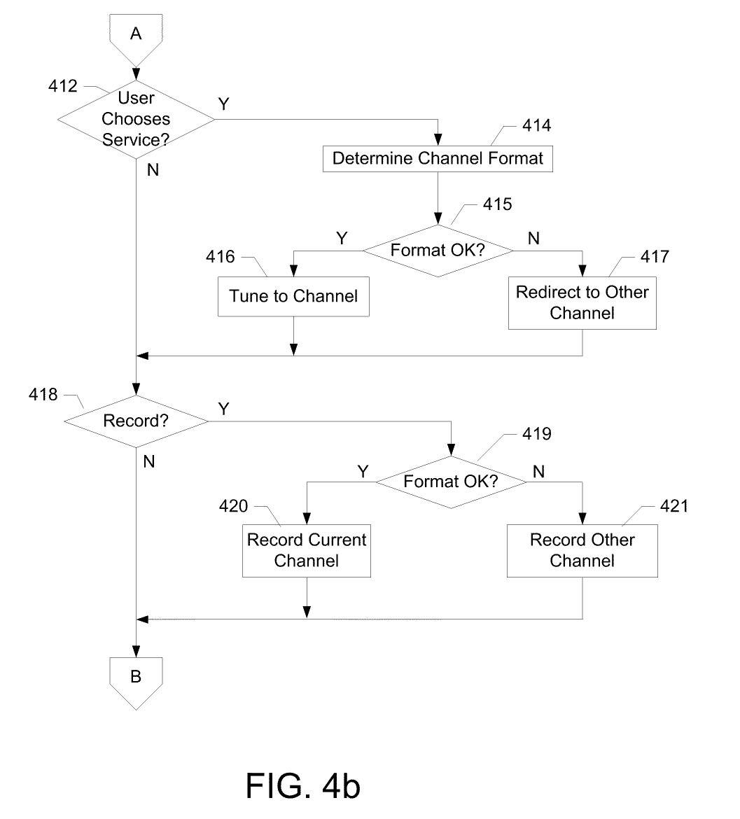

FIGS. 4a and 4b illustrate an example process by which the interface device (e.g., a DVR) 105 may customize such an EPG. Beginning in step 401, the device may first discover the display device that will be used to view content. This may occur, for example, from an initialization dialog occurring when the device is first powered up, or when it is first connected to a display device. As one example, the HDMI (High Definition Multimedia Interface) interface format includes an initialization process that occurs when an HDMI devices is connected to an HDMI interface. This initialization process includes exchanges of messages between the source device (e.g., an STB having an HDMI output port) and a consumption device (e.g., an HD television having an HDMI input port) for security and authentication purposes. In some embodiments herein, these exchanged messages may be modified to include an exchange of messages identifying the display resolution capabilities of the display device. For example, the interface device 105 may initially transmit a query to the display device for its capabilities, and the display device may respond with a message identifying those capabilities (e.g., SD only, HD-720p, HD-1080i, HD-1080p, etc.). Other examples may use different physical interfaces, such as IEEE-1394, DVI, component (possibly modified to include digital signaling), etc., and may perform similar messaging to inform the interface device 105 of the display device's capabilities.

After discovering the display device's capabilities, the interface device 105 may store information identifying those capabilities in a device profile file 402 on hard drive 205. The profile may identify one or more resolutions that are supported by the display device, and may store multiple profiles for multiple display devices (if multiple displays are connected to the interface device 105) or multiple physical interfaces (if the interface device has, for example, two component video ports). As will be explained further below, this profile information can be used by the interface device to customize a variety of aspects of the user experience.

One customization is the automatic selection of a suitable program feed for a user based on the user's television/display capability. For example, if a user's television is only able to display SD video, then the content server might only provide SD versions of selected programs.

As will also be explained below, this user experience may be customized based on user preference as well. In step 403, the device may request and obtain a user preference profile from a user, which may identify viewing resolution preferences for one or more users of the device, and conditions for those preferences. For example, one preference may indicate whether SD or HD versions of a service's programs are preferred for recording, and under what conditions. Since SD recordings typically consume less memory space than HD recordings, a viewer may indicate that recordings are preferred to be in SD to conserve space. Alternatively, the user can specify that HD recordings are generally preferred for recordings, but that SD recordings are preferred when hard drive 205 space falls below a predefined level (e.g., 25% free, 50% free, etc.). The preferences mentioned above refer to recording preferences, but similar, and distinct, preferences may be obtained for viewing as well (e.g., a user may prefer to watch current programs in HD, but record them in SD).

The preferences may also be based on program type. A viewer may specify, for example, that certain program types (e.g., movies, science fiction programs, sporting events) be viewed and/or recorded in HD, while other types (e.g., news programs, music videos, home shopping) be viewed and/or recorded in SD.

The preferences may also be based on program service provider. A viewer may specify that certain services (e.g., ESPN) be recorded and/or viewed in HD, while other services (e.g., CNN) be viewed and/or recorded in SD. Similarly, the viewer may specify that a particular service be recorded in one resolution, but viewed in another.

These preferences may be obtained using a basic onscreen form that the viewer can fill out, and which can prompt the user for input identifying his/her preferences. The resulting user preference profile information may be stored in hard drive 205.

Then, in step 404, the interface device may begin to use the profile information it has stored, and provide the customized experience mentioned above. In step 404, the device may determine whether the user has requested to view a listing of available services and/or programs, such as the EPG grid of FIG. 3. This may occur, for example, if the user presses a GUIDE button on a remote control 107 or interface device 105. If so, then the interface device may retrieve 405 the available listings from, for example, a database on hard drive 205. Those listings may be originally obtained by the interface device as part of a regular periodic download from an external server, such as a periodic EPG download in a subscription cable television network. The original listing may identify a plurality of services, and may include a channel map mapping each listed service with a datastream received by the device 105.

In step 406, the device may use the profile information to generate a filtered version of the service/program listings for display to the user. This filtered listing may customize the program listing based on the user preference and/or discovered capabilities of the viewer's display device or television. The filtered listing may remove entries for services that are no longer desired. For example, if the discovered display device is not capable of displaying an HD signal, then the interface device can filter out listings for services that are HD, so that those listings don't appear in the list shown to the user. Or, if the user has chosen to only view listings for HD programs, the device can filter out listings for the services that aren't offered in HD.

This filtered listing may also identify simulcast pairs of services, and present each service as a single virtual service in the listing, omitting the channel numbers and duplicate entries for SD/HD versions of a given service. A simulcast pair of services may be two or more services that offer the same content but in different formats, such as two versions of ESPN that offer the same sporting event, one in SD and the other in HD. So, for example, instead of having ESPN appearing twice in the EPG (e.g., once as channel 250 and again as channel 450 in the FIG. 3 example), that service can simply appear once, and without the underlying channel number. That listing for ESPN can now be considered its own virtual channel for the service, and an underlying channel map may be stored to map each listed service with two (or more) datastreams: one for recording (which may identify a datastream carrying an HD version of the service) and another for viewing (which may identify a different datastream carrying an SD version of the service).

The identification of these simulcast pairs can be done in a variety of ways. For example, the underlying EPG data, which for example may be stored in the hard drive 205, may include information identifying services as multicast pairs. Or, the device may do a textual comparison of the service names (e.g., ESPN), service identifier code, program identifier codes, etc., to identify the simulcast pairs.

In step 407, the filtered listing may be displayed to the user on the display device, and user may navigate through the listing to select a service or program for viewing or recording. This navigation may involve moving a cursor or highlight through a grid of listings, and pressing a selection button on the remote control 107 to select a program or service.

In step 408, a check may be made to determine if the user has selected a service (or a program being offered by the service). If the user has, the process may determine in step 409 whether the selection was to view or record the service. If the choice was to view the service, the device may, in step 410, consult the stored profile information to determine which version of the selected service should be tuned/decoded and displayed for the user. The profile information may indicate that the user's television is only able to display one format, such as SD content, or that the user's preference is to only view one format. In that case, the interface device may automatically tune to and decode the SD version of the selected service.

If, in step 409, the system determines that the user's selection was to record the service (or a program being offered by the service), then the interface device may, in step 411, consult the profile information to determine which version of the selected service should be recorded, and tune to, decode and record that version. Note that this recorded version may be different from the viewed version, for example if the user's television is able to support both, and the user's preference indicates one format for viewing and the other for recording.

When the viewing or recording has begun, the process may proceed to step 412, to determine whether the user has entered a command to switch to a specific service (or channel). The process may also arrive here if, back in step 408, the user makes no service selection and chooses to exist the listing in step 413. The command to switch to a particular service can be entered in a variety of ways. For example, the user may enter numeric digits on the wireless remote control 107 corresponding to a channel number for the service, or may choose a “Channel UP” or “Channel DOWN” option to change to a sequential service or channel number. Those numbers may refer to numbers that were used to logically identify services in the original EPG data (e.g., channel 250, channel 450, etc.), but with the filtering in step 406, the numbers themselves might no longer be relevant. For example, if the next numerical channel up is an HD service, but the viewer's television cannot support HD, then the present system can offer an alternative to that service.

Offering that alternative may begin in step 414, in which the interface device may determine the display format of the service that the user has requested in step 412. The display format of the service may be, for example, an HD signal at 720p resolution. In step 415, the system may check to see if such a format is compatible with the user's display device (e.g., the television), and acceptable in view of the user's profile preference information. If the format is acceptable, the system may tune to (e.g., receive, digitally decode, etc.) the requested service and display it for the user in step 416.

If the format is not acceptable, then the system may redirect the user to a different service or channel in step 417. The redirection may involve identifying an alternative datastream that is in the correct format. For example, if the user entered the channel number corresponding to an HD version of ESPN, but the user's television is not HD-compatible, then the interface device may check to see if an SD version of ESPN is available, and tune to that datastream instead. This check may be accomplished by, for example, consulting the underlying EPG data which, may be stored on hard drive 205 or another storage device, to determine if the selected service is part of a simulcast pair, and if so, it may check to determine the format of the other datastream in the pair. When the alternative datastream is found, the device may then tune to that datastream instead (e.g., by decoding a stream carrying the alternative version of the service). Although not illustrated in FIG. 4b, if no suitable alternative can be found, then the system may display an error message informing the user that the selected channel is incompatible with the user preference and/or hardware profile information. If the only incompatibility is with a user preference, the system may give the user the option of overriding that preference, but if the incompatibility is a hardware one (e.g., the television cannot display HD), then the user's request may simply be denied or failed.

Then, in step 418, the system may determine whether the user has requested to make a recording of a program on a service. The request may be made, for example, by simply pressing a RECORD button on a remote control while a program is being viewed. In response to such a request, the interface device may check 419 to determine whether the format of the datastream being viewed is compatible with the profile information, similar to that performed in step 415 above. If the format is acceptable, then the current datastream is recorded in step 420. If the format is not acceptable, then the system may, in step 421, tune to/decode an alternative datastream that carries the correct format of the service. So for example, if the user is watching an HD version of ESPN, but has specified that recordings only be made in SD to save space, the interface device may record the SD version of the program that was selected for recording. It may do this even while the HD version is being displayed to the user (provided the device has the necessary tuning and/or decoding capability to record one datastream while displaying another).

Then, the process may return to step 404, and continue looping through until the system is turned off. The process may be restarted again upon power on, or when a new display device is connected to the system, or for any other desired reason.

The FIGS. 4a & 4b process shows dynamically consulting profile information in response to user selections for viewing or recording. A variation on this approach can avoid having to check the profile information each time. Instead, a channel map may be generated for the EPG listings, where each available service can be mapped to two different datastreams: one for recording and one for viewing. The channel map may be automatically generated using the profile information. Then, when the EPG is displayed or the user makes a selection, the device 105 can simply consult the channel map to determine which datastream is mapped to the selected service or channel number.

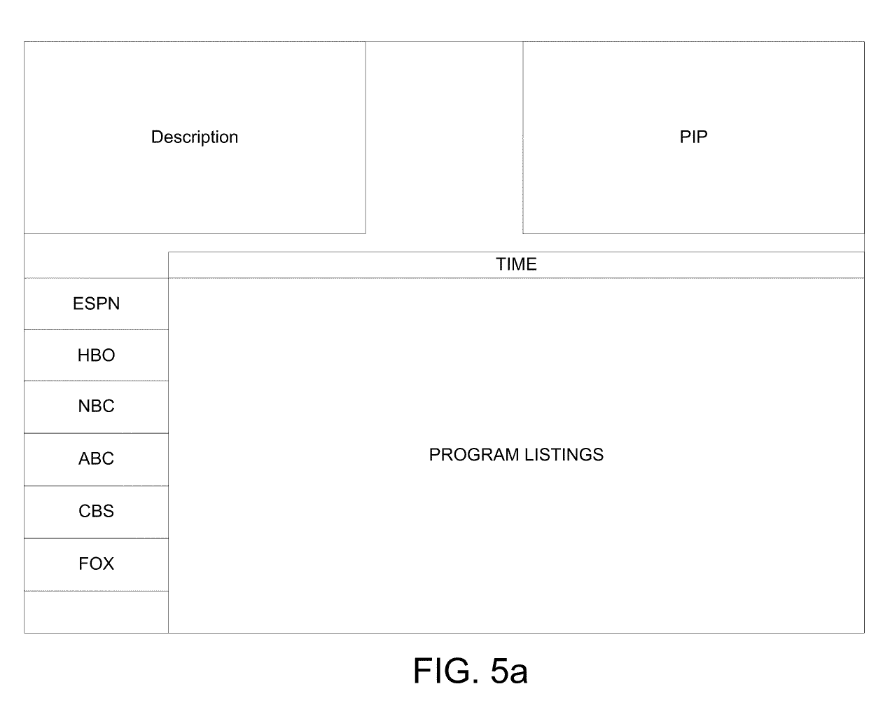

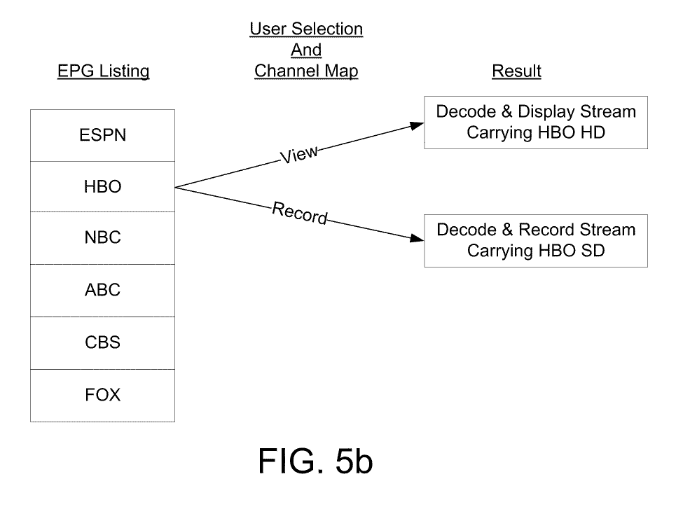

FIGS. 5a & 5b illustrate an example EPG service listing, and a logical consequence of an example profile-based selection. The FIG. 5a display is similar to the EPG from FIG. 3, although each service is now represented as a single listing, virtually representing both the SD and HD datastreams of the service (and additional data streams, if available). The FIG. 5a example shows the following services: ESPN, HBO, NBC, ABC, CBS, FOX. Each of those services may be mapped, via a channel map generated using the profile preference information, to one or more distinct datastreams carrying different versions of the service. For example, each service may be mapped to one datastream for recording, and a different datastream for viewing, where the recording and viewing datastreams may be datastreams carrying different resolution versions (e.g., SD and HD) of the service (e.g., ESPN). FIG. 5b illustrates how such a channel map may redirect viewing and recording commands for each service.

In the FIG. 5b example, the user may have indicated (for example, in the user preference profile information) that recordings of television shows be in SD, but that currently-viewed programs be presented in HD. So, if the user chooses to view the HBO service, the system may then tune to and decode for display a datastream carrying the HD version of HBO. If the user chooses to record HBO, the system can tune to and decode for recording a datastream carrying a different version—the SD version.

In the above example, content may be recorded in HD and played back on the user's HD-capable television. The playback, however, need not always occur using the HD-capable television. For example, the interface device 105 may be a gateway that can provide the recorded content to other devices within the home, using a local wireless connection or wired connection (e.g., Ethernet, MoCA, etc.). In such situations, the device 105 may determine the resolution capability of the local requesting device (e.g., a mobile television device connected via IEEE 802.11 wireless connection may have a resolution of only 480 lines), and may determine whether the recorded content is compatible. This determination may be made, for example, by querying the requesting device, or by having the requesting device transmit information in its request, identifying its capabilities, or by having the device provide this information when registering itself with the gateway 105. If the content is not compatible (e.g., a 1080p30 HD movie for playback on a 480p mobile television device), then the device 105 may transcode the content's audio and/or video to provide it in a different format that is compatible with the requesting device. In this manner, an HD movie might be recorded in HD at a user's DVR, but the user can then locally stream that movie to a different device, such as a cell phone, and watch it in a format that is compatible with that other device.

Transcoding may be performed in any desired manner. In some embodiments, a program may be transmitted using layered encoding (e.g., scalable video encoding), in which a single encoded datastream or file may carry encodings for multiple different encoded versions of a given video program or television show. Other known and future-developed methods of transcoding may also be used.

The description above provides various example embodiments, but those embodiments are merely examples. Variations may be made. For example, while the services are described in the context of video programs, other types of media (e.g., audio, textual, data, etc.) may be accessed as well, with corresponding types of resolution (e.g., audio fidelity, data rate, etc.). The various elements and steps may be subdivided, combined, and rearranged in any desired manner.

While the aspects have been described with reference to preferred and exemplary embodiments, it will be understood by those of ordinary skill in the art that various changes may be made and equivalents may be substituted for elements thereof without departing from the scope. For example, while example embodiments have been described with respect to transmission of video content, the disclosure is also applicable to transmission of other data, such as Internet Protocol data, to a user device or devices having different capabilities for rendering or displaying such data.

In addition, many modifications may be made to adapt a particular situation to the teachings herein without departing from the scope thereof. Therefore, it is intended that the aspects not be limited to the particular embodiments disclosed, but that the aspects include all embodiments falling within the scope of the appended claims.

1. A method, comprising:
obtaining, from a video interface device, user preference information identifying a first user preference for a video resolution to use when recording a video program, and a second user preference for a video resolution to use when viewing a video program, the second user preference being different from the first user preference; and
using one of said first and second user preferences to provide video content to the user.

2. The method of claim 1, further comprising:
displaying a video program in a first resolution;
receiving a record command; and
automatically recording the video program at a second resolution, different from the first, based on the preference information.

3. The method of claim 1, further comprising:
receiving a record command from a viewer who is watching a high-definition version of a video program; and
responding to the command by recording a standard definition version of the video program.

4. The method of claim 1, further comprising:
automatically detecting a display capability of a video display device connected to the interface device; and
using information identifying the detected display capability when using the preference information to provide content to the user.

5. The method of claim 4, further comprising:
using information identifying the detected display capability to generate a filtered electronic program guide (EPG) for a user.

6. The method of claim 5, further comprising using information identifying the detected display capability to combine a service's SD and HD simulcast listings into a single virtual listing for the service.

7. The method of claim 6, wherein the single virtual listing for the service omits channel numbers for the service.

8. The method of claim 1, further comprising:
generating a channel map mapping service providers with different datastreams carrying different resolution versions of programs offered by the service providers.

9. The method of claim 1, further comprising:
receiving a user request to record an HD version of a video program; and
in response to the request, redirecting the recording to record an SD version of the video program instead.

10. A method, at a server, comprising:
receiving a request for content from a user device;
automatically selecting, at the server, a resolution for the requested content based on information identifying the device's capabilities; and
transmitting the requested content, at the selected resolution, to the user device.

11. The method of claim 10, further comprising:
determining whether the request is a request to record the content, wherein the automatic selection of a resolution is further based on whether the request is a request to record.

12. The method of claim 10, further comprising:
transmitting the requested content twice, at two different resolutions, to the requesting user device for viewing and recording, respectively.

13. An interface device, comprising:
a processor; and
a computer-readable medium, storing instructions that, when executed by the processor, cause the processor to:
map a single entry in an electronic program guide (EPG) to two different versions of a program, a first version for recording the program and having a first resolution, and a second version for viewing the program and having a second resolution different from said first resolution.

14. The device of claim 13, wherein the medium further stores instructions for performing the following:
using a single EPG listing to represent a plurality of simulcast versions of the same program.

15. The device of claim 14, wherein the medium further stores instructions for performing the following:
automatically selecting a simulcast version of a selected program based on information identifying display capability of a requesting user's display device.

16. The device of claim 13, wherein the medium further stores instructions for performing the following:
providing a user with an option to select a default view resolution and default record resolution for requesting content.

17. The device of claim 13, wherein the medium further stores instructions for performing the following:
tune to and decode different resolution video streams based on whether a program selection was a view or record selection.

18. The device of claim 13, wherein the medium further stores instructions for performing the following:
automatically determine display resolution capabilities of a display device coupled to the interface device;
use information identifying the determined display resolution capabilities to determine which version of a selected program should be delivered in response to a request.

19. The device of claim 13, wherein the medium further stores instructions for performing the following:
receive a user request to tune to a channel mapped to a program having a first resolution; and
respond to the request by tuning to a channel having a different resolution.

20. The device of claim 13, wherein the medium further stores instructions for performing the following:
selecting the different channel number based on information identifying display capabilities of a requesting user's display device.
